(19) United States
(12) Patent Application Publication
(10) Pub. No.: US 2022/0372205 A1
(43) Pub. Date: Nov. 24, 2022

(54) Rigid Polyurethane Based Foam with Compression Strength and Fire Resistance

(71) Applicant: BASF SE, Ludwigshafen am Rhein (DE)

(72) Inventors: Markus SCHUETTE, Lemfoerde (DE); Christian RENNER, Lemfoerde (DE); Olaf JACOBMEIER, Lemfoerde (DE); Sirus ZARBAKHSH, Ludwigshafen (DE)

(21) Appl. No.: 17/755,611

(22) PCT Filed: Oct. 29, 2020
(86) PCT No.: PCT/EP2020/080345

§ 371 Date: May 3, 2022

(30) Foreign Application Priority Data
Nov. 6, 2019 (EP) 19207519.0

(51) Int. Cl. C08G 18/08; C08G 18/12; C08G 18/22; C08G 18/18; C08G 18/40; C08G 18/48; C08G 18/42; C08G 18/09; C08G 8/10; C08J 9/14

(52) U.S. Cl. CPC C08G 18/14; C08G 18/12; C08G 18/225; C08G 18/1816; C08G 18/1808; C08G 18/4018; C08G 18/4816; C08G 18/485; C08G 18/4879; C08G 18/4208; C08G 18/092; C08G 8/10; C08J 9/141; C08J 9/146; C08G 2101/00

(57) ABSTRACT

Described herein is a method for the preparation of a rigid polyisocyanate based foam, including mixing (a) polyisocyanate, (b) at least one compound having at least two hydrogen atoms reactive towards isocyanates, (c) optionally flame retardant, (d) blowing agent, (e) catalyst and (f) optionally further additives, to form a reaction mixture and reacting the reaction mixture to obtain the polyurethane based rigid foam where the compound reactive towards isocyanates (b) includes an aromatic polyetherpolyol (b2) and at least one compound selected from the group consisting of an aromatic polyesterpolyol (b1) and a polyetherpolyol (b3) different from polyether (b2). Also described herein is a rigid polyisocyanate based foam obtained from such a method and a polyol component for the production of a polyisocyanate based foam.

The present invention relates to a method for the preparation of a rigid polyisocyanate based foam, comprising mixing (a) polyisocyanate, (b) at least one compound having at least two hydrogen atoms reactive towards isocyanates, (c) optionally flame retardant, (d) blowing agent, (e) catalyst and (f) optionally further additives, to form a reaction mixture and reacting the reaction mixture to obtain the polyurethane based rigid foam wherein the compound reactive towards isocyanates (b) comprises an aromatic polyetherpolyol (b2) and at least one compound selected from the group consisting of an aromatic polyesterpolyol (b1) and a polyetherpolyol (b3) different from polyether (b2), the polyetherpolyol (b2) obtainable by condensation of an aromatic alcohol and an aldehyde to form a starting molecule and subsequent alkoxylation with alkylene oxide comprising ethylene oxide and propylene oxide wherein the weight ratio of propylene oxide and ethylene oxide is 70:30 to 95:5 and the hydroxyl number is 220 to 400 mg KOH/g. The present invention further relates to a rigid polyisocyanate based foam obtained from such a method and a polyol components for the production of a polyisocyanate based foam according to the invention.

Polyisocyanate based rigid foams have long been used in the construction industry for thermal insulation due to their extremely low thermal conductivity and high mechanical stability. They are often used as core layer of insulation boards with flexible cover and as core layer of structural sandwich panels with rigid cover layers. Such insulation boards or structural sandwich panels are often referred to as sandwich elements. Nowadays, such sandwich elements are produced in continuous operation for example on commonly known double belt lines or in discontinuous operation, either on a so called flatlaminator or in one-shot-technique in a closed mold.

Polyisocyanate based rigid foams comprise polyurethane rigid foams and polyisocyanurate rigid foams. A polyisocyanurate rigid foam is usually understood to be a foam that contains both urethane and isocyanurate groups. In the context of the invention, the term polyurethane rigid foam is also intended to include rigid polyisocyanurate foam, whereby the production of polyisocyanurate foams is based on isocyanate ratios greater than 180. Polyurethane rigid foams are usually produced at an isocyanate index of 90 to less than 180.

A major problem of the polyisocyanurate rigid foams known today according to the state of the art is insufficient foam adhesion to the rigid metallic surface layers. To remedy this deficiency, an adhesion promoter is usually applied between the lower layer and the foam, as described for example in EP1516720. In addition, high molding temperatures of >60° C. are required during processing to ensure sufficient trimerization of the polyisocyanate components (especially in zones close to the surface), which leads to a higher crosslinking density and thus to better temperature stability, compressive strength and flame resistance in the foam.

Compared to polyisocyanurate rigid foams, polyurethane rigid foams usually exhibit significantly better foam adhesion to the metallic surface layers and can be converted at significantly lower processing temperatures. To achieve the required fire resistance, however, a very high proportion of liquid halogen-containing flame retardants is usually required.

DE 19528537 A1 describes, for example, a process for the production of polyurethane rigid foams in which large quantities of chlorine, bromine and phosphorus compounds are used in the polyol component.

For ecotoxic reasons and due to improved fire side effects, however, it is desirable to keep the use of halogenated flame retardants, especially brominated flame retardants, in the polyol component as low as possible. The pure use of halogen-free flame retardants liquid at room temperature in rigid polyurethane foams based on polyether polyols, especially in combination with conventional flammable physical blowing agents such as n-pentane or cyclopentane, either makes it impossible to achieve the necessary flame retardancy standards or requires severe restrictions in the mechanics or processing of the rigid foam. For example, when solid halogen-free flame retardants such as melamine, ammonium sulphate, expanded graphite and ammonium polyphosphate are used, dosing and processing problems occur and the mechanical properties of the rigid foam are significantly reduced at the same densities (see also EP 0665251 A2).

The compressive strength of rigid foams significantly determines the minimum foam density required for manufacturing proper sandwich elements and thus has a direct influence on material consumption and insulation properties. In addition, especially for the use as facade elements a high flame resistance of the polyisocyanate based foam is essential.

In the production of highly flame-retardant foams with high compressive strength, novolac based polyetherols, also called phenolic polyols, are frequently used since they enable a high flame resistance and therefore allow the reduction of flame retardants. This leads to better mechanical properties and allows to reduce the density of the foam.

DE 1595509 describes the synthesis of Novolac resins and corresponding polyols obtained by propoxylation, as well as use of those polyols in combination with amino polyols for the preparation of PU foams.

WO2004/063243 describes polyol compositions suitable for the preparation of a rigid foam containing aromatic polyoxyalkylene polyol based on an initiator obtained from the condensation of a phenol with an aldehyde.

WO2010/114695 describes storage stable polyol compositions comprising a) 1-20 wt. % aliphatic polyesterpolyol, 1-60 wt. % aromatic polyester polyol, 1-60 wt. % of a Novolac-type polyether polyol and 1-20 wt. % hydrofluorocarbon blowing agent.

WO2010/114703 describes polyol compositions suitable for the preparation of a rigid foam containing 20-60 wt. % aromatic polyester polyol, 10-30 wt. % of a Novolac-type polyether polyol and 5-40 wt. % sucrose- or sorbitol-based polyol having an hydroxyl number of 200 mg KOH/g and a functionality of at least 4.

WO2012/083038 describes polyol composition suitable for the preparation of a rigid polyisocyanurate foam (PIR foam) having an isocyanate index of more than 250, containing 20-60 wt. % aromatic polyester polyol, 10-30 wt. % of a Novolac-type polyether polyol having OH number greater than 100 and functionality of at least 2.2, and 5-40 wt. % sucrose- or sorbitol-based polyol.

In the examples of WO2010114695, WO2010114703 and WO2010114703 Polyol IP585 was used as Novolac polyol being oxypropylene-oxyalkylene adducts based on phenol-formaldehyde condensate having an average functionality of about 3.3 and OH number 195 mg KOH/g.

In the examples of us 20110184081 a Novolak-type polyether polyol obtained by propoxylation and ethoxylation of the condensation product of phenol and formaldehyde, having a OH-Number of 300 mg KOH/g and a molar ratio of ethylene oxide to propoylene oxide of 1:1. This novolac type polyol is used together with an alkoxylated aromatic diamine type polyether.

In WO2016/064948 novolac polyols obtainable from the alkoxylation of phenolic resins are used for the production of rigid foams wherein the use of such polyols having primary hydroxyl groups is preferred.

Regarding the state of the art there is still the need of further improving flame resistance and compressive strength as well as adhesion to the cover layers of sandwich elements. It therefore has been object of the present invention to further improve flame retardancy and compressive strength as well as adhesion to conventional cover layers of sandwich elements of rigid foams based on polyisocyanate.

The object of the present invention is solved by a method for the preparation of a polyisocyanate based rigid foam, comprising mixing (a) polyisocyanate, (b) at least one compound having at least two hydrogen atoms reactive towards isocyanates, (c) optionally flame retardant, (d) blowing agent, (e) catalyst and (f) optionally further additives, to form a reaction mixture and reacting the reaction mixture to obtain the polyurethane based rigid foam wherein the compound reactive towards isocyanates (b) comprises an aromatic polyetherpolyol (b2) and at least one compound selected from the group consisting of an aromatic polyesterpolyol (b1) and a polyetherpolyol (b3) different from polyether (b2), the polyetherpolyol (b2) obtainable by condensation of an aromatic alcohol and an aldehyde to form a starting molecule and subsequent alkoxylation with alkylene oxide comprising ethylene oxide and propylene oxide wherein the weight ratio of propylene oxide and ethylene oxide is 70:30 to 95:5 and the hydroxyl number is 220 to 400 mg KOH/g. The object is further solved by a rigid polyisocyanate based foam obtained from such a method and a polyol components for the production of a polyisocyanate based foam according to the invention.

In the context of the invention, polyisocyanate based rigid foam is defined as a foam comprising urethane groups as a polyurethane or a polyisocyanurate, preferably a foam according to DIN 7726, which has a compressive strength according to DIN 53 421/DIN EN ISO 604 of greater than or equal to 80 kPa, preferably greater than or equal to 120 kPa, particularly preferably greater than or equal to 150 kPa and especially greater than 180 kPa. Furthermore, in a preferred embodiment the rigid polyisocyanate based foam according to DIN ISO 4590 has a closed cell content of more than 50%, more preferred more than 85% and particularly preferably more than 90%.

The polyisocyanates (a) are the aliphatic, cycloaliphatic, araliphatic and preferably the aromatic polyvalent isocyanates known in the art. Such polyfunctional isocyanates are known and can be produced by methods known per se. The polyfunctional isocyanates can also be used in particular as mixtures, so that component (a) in this case contains various polyfunctional isocyanates. Polyisocyanate (a) is a polyfunctional isocyanate having two (hereafter called diisocyanates) or more than two isocyanate groups per molecule.

In particular, isocyanate (a) are selected from the group consisting of alkylenediisocyanates with 4 to 12 carbon atoms in the alkylene radical, such as 1,12-dodecanediioscyanate, 2-ethyltetramethylene-1,4-diisocyanate,2-methylpentamethylene-1,5-diisocyanate, tetramethylene-1,4-diisocyanate, and preferably hexamethylene-1,6-diisocyanate; cyc-loaliphatic diisocyanates such as cyclohexane-1,3- and 1,4-diisocyanate and any mixtures of these isomers, 1-isocyanato-3,3,5-trimethyl-5-isocyanatomethylcyclohexane (IPDI), 2,4- and 2,6-hexahydrotoluene diisocyanate and the corresponding isomer mixtures, 4,4′-, 2,2′- and 2,4′-dicyclohexylmethane diisocyanate and the corresponding isomer mixtures, and preferably aromatic polyisocyanates, such as 2,4- and 2,6-toluene diisocyanate and the corresponding isomer mixtures, 4,4′-, 2,4′- and 2,2′-diphenylmethane diisocyanate and the corresponding isomer mixtures, mixtures of 4,4′- and 2,4′-diphenylmethane diisocyanates, Polyphenylpolymethylene polyisocyanates, mixtures of 4,4′-, 2,4′- and 2,2′-diphenylmethane diisocyanates and polyphenylpolyethylene polyisocyanates (crude MDI) and mixtures of crude MDI and toluene diisocyanates.

Particularly suitable are 2,2′-, 2,4′- and/or 4,4′-diphenylmethane diisocyanate (MDI), 1,5-naphthylene diisocyanate (NDI), 2,4- and/or 2,6-toluene diisocyanate (TDI), 3,3′-dimethyl diphenyl diisocyanate, 1,2-diphenylethane diisocyanate and/or p-phenylene diisocyanate (PPDI), tri-, tetra-, penta-, hexa-, hepta- and/or octamethyl diisocyanate, 2-methylpentamethylene-1,5-diisocyanate, 2-ethylbutylene-1,4-diisocyanate, pentamethylene-1,5-diisocyanate, butylene-1,4-diisocyanate, 1-isocyanato-3,3,5-trimethyl-5-iso-cyanatomethyl-cyclohexane (isophorone diisocyanate, IPDI), 1,4- and/or 1,3-Bis(isocyanatomethyl)cyclohexane (HXDI), 1,4-cyclohexane diisocyanate, 1-methyl-2,4- and/or -2,6-cyclohexane diisocyanate and 4,4′-, 2,4′- and/or 2,2′-dicyclohexylmethane diisocyanate.

Modified polyisocyanates, i.e. products obtained by the chemical reaction of organic polyisocyanates and containing at least two reactive isocyanate groups per molecule, are also frequently used. Particularly mentioned are polyisocyanates containing ester, urea, biuret, allophanate, carbodiimide, isocyanurate, uretdione, carbamate and/or urethane groups, often also together with unreacted polyisocyanates.

The polyisocyanates of component (a) particularly preferably contain 2,2′-MDI or 2,4′-MDI or 4,4′-MDI or mixtures of at least two of these isocyanates (also referred to as monomeric diphenylmethane or MMDI) or oligomeric MDI consisting of higher-core homologues of the MDI which have at least 3 aromatic nuclei and a functionality of at least 3, or mixtures of two or more of the above-mentioned diphenylmethane diisocyanates, or crude MDI obtained in the preparation of MDI, or preferably mixtures of at least one oligomer of the MDI and at least one of the above-mentioned low molecular weight MDI derivatives 2,2′-MDI, 2,4′-MDI or 4,4′-MDI (also referred to as polymeric MDI). Usually the isomers and homologues of the MDI are obtained by distillation of crude MDI.

The (average) functionality of a polyisocyanate containing polymeric MDI may vary in the range from about 2.2 to about 4, in particular from 2.4 to 3.8 and in particular from 2.6 to 3.0.

Polyfunctional isocyanates or mixtures of several polyfunctional isocyanates based on MDI are known and are commercially available from BASF Polyurethanes GmbH under the trade name Lupranat® M20, Lupranat® M50 or Lupranat® M70.

Component (a) preferably contains at least 70, particularly preferably at least 90 and in particular 100 wt. %, based on the total weight of components (a), of one or more isocyanates selected from the group consisting of 2,2′-MDI, 2,4′-MDI, 4,4′-MDI and oligomers of the MDI. The content of oligomeric MDI is preferably at least 20% by weight, particularly preferably greater than 30% to less than 80% by weight, based on the total weight of component (a).

The viscosity of the component (a) used can vary over a wide range. Component (a) preferably has a viscosity of 100 to 3000 mPa*s, especially preferred from 100 to 1000 mPa*s, especially preferred from 100 to 700 mPa*s, more especially from 200 to 650 mPa*s and especially from 400 to 600 mPa*s at 25° C. The viscosity of component (a) may vary within a wide range.

The compound reactive towards isocyanates (b) comprises an aromatic polyetherpolyol (b2) and at least one compound selected from the group consisting of an aromatic polyesterpolyol (b1) and a polyetherpolyol (b3) different from polyether (b2), the polyetherpolyol (b2) obtainable by condensation of an aromatic alcohol and an aldehyde to form a starting molecule and subsequent alkoxylation with alkylene oxide comprising ethylene oxide and propylene oxide wherein the weight ratio of propylene oxide and ethylene oxide is 70:30 to 95:5 and the hydroxyl number is 220 to 400 mg KOH/g. Component (b) further may comprise at least one polyetherpolyol (b3) and/or at least one chain extender or crosslinking agent (b4).

Suitable polyester polyols (b1) can preferably be produced from aromatic dicarboxylic acids or mixtures of aromatic and aliphatic dicarboxylic acids, especially preferably exclusively from aromatic dicarboxylic acids and polyhydric alcohols. Instead of free dicarboxylic acids, the corresponding dicarboxylic acid derivatives, such as dicarboxylic acid esters of alcohols with 1 to 4 carbon atoms or dicarboxylic acid anhydrides, can also be used.

As aromatic dicarboxylic acids or as aromatic dicarboxylic acid derivatives preferably phthalic acid, phthalic anhydride, terephthalic acid and/or isophthalic acid are used in the mixture or alone, preferably phthalic acid, phthalic anhydride and terephthalic acid are used. Especially preferred is the use of terephthalic acid or dimethyl terephthalate, most preferred terephthalic acid. Aliphatic dicarboxylic acids can be used in a minor amount together with aromatic dicarboxylic acids in the mixture. Examples of aliphatic dicarboxylic acids are succinic acid, glutaric acid, adipic acid, cork acid, azelaic acid, sebacic acid, decandicarboxylic acid, maleic acid and fumaric acid.

Examples of polyvalent alcohols are: ethylene glycol, diethylene glycol, 1,2- or 1,3-propanediol, dipropylene glycol, 1,4-butanediol, 1,5-pentanediol, 1,6-hexanediol, 1,10-decanediol, glycerol, trimethylolpropane and pentaerythritol or their alkoxylates. Preferably used are ethylene glycol, diethylene glycol, propylene glycol, glycerol, trimethylolpropane or their alkoxylates or mixtures of at least two of the mentioned polyols.

In a preferred embodiment of the invention, a polyether polyol which is a reaction product of glycerol and/or trimethylolpropane with ethylene oxide and/or propylene oxide, preferably with ethylene oxide, is also used as a polyhydric alcohol, the OH number of the polyether polyol preferably being between 500 and 750 mg KOH/g. This results in improved storage stability of the component (b1).

In addition to aromatic dicarboxylic acids or their derivatives and polyhydric alcohols, biobased starting materials and/or their derivatives are also suitable for the production of polyester polyols (b1), e.g. fatty acids or fatty acid derivatives as Castor oil, polyhydroxy fatty acids, ricinoleic acid, hydroxyl-modified oils, grape seed oil, black cumbel oil, pumpkin seed oil, borage seed oil, soybean oil, wheat seed oil, Rapeseed oil, sunflower seed oil, peanut oil, apricot kernel oil, pistachio oil, almond oil, olive oil, macadamia nut oil, avocado oil, sea buckthorn oil, sesame oil, hemp oil, hazelnut oil, primrose oil, wild rose oil, safflower oil, walnut oil, fatty acids, hydroxyl modified fatty acids and fatty acid esters based on myristoleic acid, palmitoleic acid, oleic acid, vaccenoic acid, petroselinic acid, gadoleinic acid, erucic acid, nervonic acid, linoleic acid, o,- and y-linolenic acid, stearidonic acid, arachidonic acid, timnodonic acid, clupanodonic acid and cervonic acid.

A preferred form of the present invention is the fatty acid or the fatty acid derivative oleic acid, biodiesel, soya oil, rapeseed oil or tallow, particularly preferred is oleic acid or biodiesel and in particular oleic acid. The fatty acid or fatty acid derivative improves, among other things, the blowing agent solubility in the production of polyurethane rigid foams.

In a preferred embodiment the aromatic polyesterpolyol (b1) is obtainable by esterification of dicarboxylic acid composition comprising one or more aromatic dicarboxylic acids or derivatives thereof, one or more fatty acids or fatty acid derivatives, one or more aliphatic or cycloaliphatic alcohols with functionality of 2 or more having 2 to 18 carbon atoms or alkoxylates thereof.

In order to prepare the polyester polyols (b1), the aliphatic and aromatic polycarboxylic acids and/or derivatives and polyhydric alcohols may be polycondensed, catalyst-free or preferably in the presence of esterification catalysts, expediently in an atmosphere of inert gas such as nitrogen in the melt at temperatures of 150 to 280° C., preferably 180 to 260° C., optionally under reduced pressure up to the desired acid number, which is advantageously less than 10, preferably less than 2. For example, iron, cadmium, cobalt, lead, zinc, antimony, magnesium, titanium and tin catalysts in the form of metals, metal oxides or metal salts may be used as esterification catalysts. However, polycondensation can also be carried out in the liquid phase in the presence of diluents and/or entraining agents such as benzene, toluene, xylene or chlorobenzene for the azeotropic distillation of condensation water.

To prepare the polyester polyols (b1), the organic polycarboxylic acids and/or derivatives and polyhydric alcohols are advantageously polycondensed in a molar ratio of 1:1 to 2.2, preferably 1:1.05 to 2.1 and particularly preferably 1:1.1 to 2.0.

Preferably the polyester polyol (b1) has a number-weighted average functionality of greater than 1.8, more preferred greater or equal to 2 particularly preferably greater than 2.2 and in particular greater than 2.3, which leads to a higher crosslinking density of the polyurethane produced thereby and thus to better mechanical properties of the polyurethane foam. Generally the functionality of the polyester polyol (b1) is less than 6, preferably less than 4, more preferably less than 3.5 and most preferred less than 3.0.

The polyester polyols (b1) obtained generally have a number average molecular weight of 200 to 2000 g/mol, preferably 300 to 1000 g/mol and in particular 400 to 700 g/mol. The OH number of polyester polyols (b1) is preferably 100 to 800, especially preferred from 600 to 150 and especially from 400 to 200 mg KOH/g.

The polyetherpolyol (b2) is obtainable by condensation of an aromatic alcohol, i.e. a molecule having an hydroxyl group directly bonded to an aromatic moiety, and an aldehyde to form a starting molecule and subsequent alkoxylation with alkylene oxide comprising ethylene oxide and propylene oxide.

The condensation of an aromatic alcohol and an aldehyde is conducted in the presence of an acid catalyst. Usually a small amount of the acid catalyst or catalysts is/are added to a miscible aromatic alcohol, followed by aldehyde addition.

The aromatic alcohol is not particularly limited and may be chosen as desired for a particular purpose or intended application. In one embodiment, the aromatic alcohol is selected from the group consisting of phenol, o-cresol, m-cresol, p-cresol, bisphenol A, bisphenol F, bisphenol S, alkylphenols like p-tert. butylphenol, p-tert. amylphenol, p-iso-propylphenol, p-tert. octylphenol, nonylphenol, dodecylphenol, p-cumylphenol, xylenols (dimethylphenols), ethylphenols, p-phenylphenol, alpha and beta naphthols, resorcinol, methylresorcinols, cashew nut shell liquid (CNSL) as C 15 alkylphenol, halogenated phenols like p-chlorophenol, o-bromophenol, etc., or combinations of two or more thereof. The preferred aromatic alcohol is unsubstituted phenol.

Examples of suitable aldehydes for forming novolac-type is selected from the group consisting of formaldehyde, acetaldehyde, propionaldehyde, butyraldehyde, benzaldehyde, furfuryl aldehyde, glyoxal etc., or combinations of two or more thereof. The preferred aldehyde is formaldehyde.

Suitable acid catalysts that may be employed to form a novolac-type resin include, but are not limited to, oxalic acid, p-toluene sulfonic acid, benzene sulfonic acid, hydrochloric acid, sulfuric acid, phenol sulfonic acid, metal salts, mixtures of two or more thereof, etc. Suitable basic catalyst are metal hydroxides, metal carbonates, amines, imidazoles.

Suitable aromatic polyether polyols (b2) may be produced, for example, by reacting a condensate adduct of phenol and formaldehyde with ethylene oxide and propylene oxide. Such polyols, sometimes referred to as Novolac-initiated polyols, are known to those skilled in the art, and may be obtained by methods such as are disclosed in, for example, U.S. Pat. Nos. 2,838,473; 2,938,884; 3,470,118; 3,686,101; and 4,046,721. Typically, Novolac starting materials are prepared by reacting a phenol (for example, a cresol) with from about 0.8 to about 1.5 moles of formaldehyde per mole of the phenol in the presence of an acidic catalyst to form a polynuclear condensation product containing from 2.1 to 12, preferably from 2.2 to 6, and more preferably from 2.7 to 5 phenol units per molecule. The aromatic starting material is then reacted with an alkylene oxide comprising ethylene oxide and propylene oxide, to form an oxyalkylated product containing a plurality of hydroxyl groups. For the purpose of the present invention, preferred aromatic polyether polyols are those having an average hydroxyl number of from 220 to 400 mg KOH/g, preferably from 250 to 350 mg KOH/g and more preferably 280 to 330 mg KOH/g. According to the present invention the ration of propylene oxide and ethylene oxide is 70:30 to 95:5, preferably 70:30 to 90:10, more preferably 75:25 to 85:15. In a preferred embodiment the aromatic polyetherol (b2) comprises exclusively ethylene oxide and propylene oxide groups as alkoxyl groups.

In a preferred embodiment the aromatic polyether polyol (b2) is obtainable by ethoxylation of the condensation product of the aromatic alcohol and the aldehyde in a first step to a hydroxyl value of 300 to 500 mg KOH/g, followed by propoxylation. Preferably after ethoxylation of the aromatic starter molecule the resulting ether contains on average at least one molecule of ethylene oxide. It is not necessary to clean the ethoxylated starter molecule after ethoxylation and before propoxylation. To follow the reaction progress, the conversion of the alkylene oxide can be monitored spectroscopically, e.g. by IR spectrometry. Before adding the final propylenoxide, the conversion of alkylene oxide is preferably checked by spectroscopic methods so that essentially no unreacted ethylene oxide is present in the reaction mixture. This means that the proportion of unreacted ethylene oxide before addition of the propylene oxide is less than 1 wt. %, preferably less than 0.5 wt. %, more preferably less than 0.1 wt. % and in particular less than 0.01 wt. %, based on the total weight of the alkylene oxide used up to this point in time. Work up of the polyol (b2) after production is not necessary. In a preferred embodiment the basic catalyst is removed from the polyol (b2) after production. In a preferred embodiment the aromatic polyether polyol (b2) has less than 30% of primary OH groups, more preferred less than 20% of primary OH groups and especially preferred less than 10% of primary OH groups, each based on the total number of OH-Groups in the polyetherol (b2).

The resulting aromatic polyetherpolyol (b2) preferably has an average OH-functionality of 2.7 to 5 and preferably comprises 70 to 100%, more preferred 80 to 100% and most preferably 90 to 100% secondary OH-groups, based on the total number of OH groups in polyetherpolyol (b2).

Preferably the polyetherpolyol (b3) is obtained by alkoxylation of an aliphatic starting molecule or a mixture of aliphatic starting molecules. Preferably the polyetherols (b3) are obtained in the presence of catalysts by known methods, for example by anionic polymerization of alkylene oxides with addition of at least one starter molecule containing 2 to 8, preferably 2 to 6, reactive hydrogen atoms bonded, the average functionality of the starter molecules being in a preferred embodiment at least 3. The nominal functionality of the polyetherols preferably is therefore at least 3, more preferably 3 to 6, and refers to the functionality of the starter molecules. If mixtures of starter molecules with different functionality are used, fractional functionalities can be obtained. Influences on functionality, for example by side reactions, are not considered in the nominal functionality. Alkali hydroxides such as sodium or potassium hydroxide or alkali alcoholates such as sodium methylate, sodium or potassium methylate or potassium isopropylate can be used as catalysts, or Lewis acids such as antimony pentachloride, boron trifluoride etherate or bleaching earth can be used as catalysts in cationic polymerization. Aminic alkoxylation catalysts such as dimethylethanolamine (DMEOA), imidazole and imidazole derivatives can also be used. Double metal cyanide compounds, so-called DMC catalysts, can also be used as catalysts for the production of the polyetherpolyol (b3).

One or more compounds with 2 to 4 carbon atoms in the alkylene radical, such as tetrahydrofuran, 1,2-propylene oxide, ethylene oxide, 1,2- or 2,3-butylene oxide, are preferably used as alkylene oxides, either alone or in the form of mixtures. Preferably used are ethylene oxide and/or 1,2-propylene oxide, in particular exclusively 1,2-propylene oxide.

The starter molecules are compounds containing hydroxyl groups or amine groups, such as ethylene glycol, diethylene glycol, glycerol, trimethylolpropane, pentaerythritol, sugar derivatives such as sucrose, hexite derivatives such as sorbitol, methylamine, ethylamine, isopropylamine and butylamine, benzylamine, aniline, toluidine, toluenediamine (TDA), naphthylamine, ethylenediamine, diethylenetriamine, 4,4-methylenedianiline, 1,3,-propanediamine, 1,6-hexanediamine, ethanolamine, diethanolamine, triethanolamine, and other two or more valent alcohols or one or more valent amines. Since these highly functional compounds are present in solid form under the usual reaction conditions of alkoxylation, it is common practice to alkoxylate them together with co-initiators. Suitable co-initiators are e.g. water, polyfunctional lower alcohols, e.g. glycerine, trimethylolpropane, pentaerythritol, diethylene glycol, ethylene glycol, propylene glycol and their homologues. Further co-initiators are for example: organic fatty acids, fatty acid monoesters or fatty acid methyl esters such as oleic acid, stearic acid, oleic acid methyl ester, stearic acid methyl ester or biodiesel, which serve to improve the blowing agent solubility in the production of rigid polyurethane foams. In a preferred embodiment the average functionality of the starter molecules is at least 3.

Preferred starter molecules for the production of polyether polyols (b3) are sorbitol, saccharose, ethylenediamine, TDA, trimethylolpropane, pentaerythritol, glycerol, biodiesel and diethylene glycol. Particularly preferred starter molecules are sucrose, glycerol, biodiesel, TDA and ethylenediamine, especially sucrose, ethylenediamine and/or toluylenediamine.

In an further preferred embodiment the starting molecules for the production of polyether polyols (b3) are free of amine group containing compounds and is selected from the group, consisting of sorbitol, saccharose, trimethylolpropane, pentaerythritol, glycerol, biodiesel diethylene glycol and mixtures of two or more of these compounds.

The polyether polyols (b3) preferably have a functionality of 3 to 6 and in particular 3.5 to 5.5 and number average molecular weights of preferably 150 to 1200, in particular 200 to 800 and in particular 250 to 600. The OH number of polyether polyols of the components (b1) is preferably from 1200 to 100 mg KOH/g, preferably from 1000 to 200 mg KOH/g and in particular from 800 to 350 mg KOH/g.

In one embodiment compound (b) comprises aromatic polyesterpolyol (b1) and polyether polyols (b3).

Component (b) may also contain chain extenders and/or cross-linking agents (b4), for example to modify mechanical properties such as hardness. Diols and/or triols and amino alcohols with molecular weights of less than 150 g/mol, preferably from 60 to 130 g/mol, are used as chain extenders and/or crosslinking agents. Examples are aliphatic, cycloaliphatic and/or araliphatic diols with 2 to 8, preferably 2 to 6 carbon atoms, such as ethylene glycol, 1,2-propylene glycol, diethylene glycol, dipropy-lenglycol, 1,3-propanediol, 1,4-butanediol, 1,6-hexanediol, o-, m-, p-dihydroxycyclohexane, bis-(2-hydroxyethyl)-hydroquinone. Also considered are aliphatic and cyc-loaliphatic triols such as glycerol, trimethylolpropane and 1,2,4- and 1,3,5-trihydroxycyclohexane.

If chain extenders, crosslinking agents or mixtures thereof are used for the production of the rigid polyurethane foams, these are purposefully used in an amount of from 0 to 15% by weight, preferably from 0 to 5% by weight, based on the total weight of component (b). Component (b) preferably contains less than 2% by weight and particularly preferably less than 1% by weight and in particular no chain extender and/or crosslinking agent (b4).

In a particularly advantageous embodiment of the present invention, component (b) consists of a mixture of 0 to 70 parts by weight, in particular more than 0 to 60 parts by weight, of the aromatic polyester polyol (b1), 5 to 50 parts by weight, in particular 10 to 40 parts by weight, of the aromatic polyether polyol (b2), 10 to 70 parts by weight, in particular 20 to 60 parts by weight, of the polyether polyol (b3) and 0 to 15 parts by weight of chain extenders and/or crosslinking agents (b4).

The component (b) used in accordance with the invention has a medium hydroxyl number of 300 to 600 mg KOH/g, preferably 350 to 550 mg KOH/g and in particular 400 to 550 mg KOH/g. The hydroxyl value is determined in accordance with DIN 53240.

Flame retardants (c) can generally be the state of the art flame retardants. Suitable flame retardants include brominated esters, brominated ethers or brominated alcohols such as dibromo-neopentyl alcohol, tribromine neopentyl alcohol and tetrabromophthalate diol, as well as chlorinated phosphates such as tris-(2-chloroethyl)-phosphate, tris-(2-chloroisopropyl)-phosphate (TCPP), Tris-(1,3-dichloropropyl)-phosphate, tetrakis-(2-chloroethyl)-ethylene diphosphate, and other well known flame retardants as trikresylphosphate, 10 tris-(2,3-dibromopropyl)-phosphate dimethyl methane phosphonate, diethanol amino-methyl phosphonic acid diethylester, as well as commercial halogen-containing flame retardant polyols. As further phosphates or phosphonates diethylethan phosphonate (DEEP), triethylphosphate (TEP), dimethyl-propylphosphonate (DMPP), diphenylkre-sylphosphate (DPK) can be used as liquid flame retardants.

In addition to the flame retardants already mentioned, inorganic or organic flame retardants such as red phosphorus, red phosphorus-containing finishing agents, aluminium oxide hydrate, antimony trioxide, arsenic oxide, ammonium polyphosphate and calcium sulphate, expanded graphite or cyanuric acid derivatives such as melamine, or mixtures of at least two flame retardants, e.g. ammonium polyphosphates and melamine, and, where appropriate, maize starch or ammonium polyphosphate, melamine, expanded graphite and, where appropriate, aromatic polyesters may be used to make the polyurethane rigid foams flame retardant. In a preferred embodiment these solid flame retardants are not used.

Preference shall be given to flame retardants which are liquid at room temperature. Particularly preferred are TCPP, TEP, DEEP, DMPP, DPK, brominated ethers, tetrabromophthalate diol and tribromoneopentyl alcohol, especially TCPP, TEP and tribromoneopentyl alcohol and especially TCPP.

In general, the proportion of flame retardant (c) is 10 to 55 wt. %, preferably 20 to 50 wt. %, especially 25 to 40 wt. %, based on the sum of components (b) to (f).

According to the invention at least one blowing agent (d) is used. Preferably water, formic acid and mixtures thereof belong to the blowing agents used for the production of rigid polyurethane foams. These react with isocyanate groups to form carbon dioxide and, in the case of formic acid, carbon dioxide and carbon monoxide. Since these blowing agents release the gas through a chemical reaction with the isocyanate groups, they are referred to as chemical blowing agents. In a preferred embodiment the chemical blowing agent comprises formic acid. Preferably water, formic acid-water mixtures or formic acid are used as chemical blowing agents, especially preferred chemical blowing agents are water or formic acid-water mixtures.

In addition, physical propellants can be used. Especially suitable are liquids which are inert to the isocyanates used and have boiling points below 100° C., preferably below 50° C. at atmospheric pressure, so that they evaporate under the influence of the exothermic polyaddition reaction. Examples of such preferably used liquids are aliphatic or cyc-loaliphatic hydrocarbon compounds with 4 to 8 carbon atoms, such as heptane, hexane and iso-pentane, preferably technical mixtures of n- and iso-pentanes, n- and iso-butane and propane, cycloalkanes, such as cyclopentane and/or cyclohexane, ethers, such as furan, dimethyl ether and diethyl ether, Ketones, such as acetone and methyl ethyl ketone, alkyl carboxylates, such as methyl formate, dimethyl oxalate and ethyl acetate and halogenated hydrocarbons, such as methylene chloride, Dichloromonofluoromethane, difluoromethane, trifluoromethane, difluoro-rethane, tetrafluoroethane, chlorodifluoroethane, 1,1-dichloro-2,2,2-trifluoroethane, 2,2-dichloro-2-fluoroethane and heptafluoropropane. Mixtures of these low-boiling liquids with one another and/or with other substituted or unsubstituted hydrocarbons may also be used as physical blowing agents.

As physical blowing agent also unsaturated fluorinated hydrocarbons (HFO) may be used. In a preferred embodiment such HFO's are composed of 2 to 5, preferably 3 or 4 carbon atoms, at least one hydrogen atom and at least one fluorine and/or chlorine atom, the HFO containing at least one carbon-carbon double bond. Suitable HFO's according to the present invention comprise trifluoropropenes and tetrafluoropropenes such as (HFO-1234), pentafluoropropenes such as (HFO-1225), chlorotrifluoropropenes such as (HFO-1233), chlorodifluoropropenes and chlorotetrafluoropropenes and mixtures of one or more of these components. Particularly preferred are tetrafluoropropenes, pentafluoropropenes and chlorotrifluoropropenes, where the unsaturated terminal carbon atom carries more than one chlorine or fluorine substituent. Examples are 1,3,3,3-tetrafluoropropene (HFO-1234ze); 1,1,3,3-tetrafluoropropene; 1,2,3,3,3-pentafluoropropene (HFO-1225ye); 1,1,1-trifluoropropene; 1,1,1,3,3-pentafluoropropene (HFO-1225zc); 1,1,1,3,3,3-hexafluorobut-2-ene, 1,1,2,3,3-pentafluoropropene (HFO-1225yc); 1,1,1,2,3-pentafluoropropene (HFO-1225yez); 1-chloro-3,3,3-trifluoropropene (HCFO-1233zd); 1,1,1,4,4,4-hexafluorobut-2-ene or mixtures of two or more thereof.

Particularly preferred HFO's are hydrofluoroolefins selected from the group consisting of trans-1-chloro-3,3,3-trifluoropropene (HCFO-1233zd(E)), cis-1-chloro-3,3,3-trifluoropropene (HCFO-1233zd(Z)), trans-1,1,1,4,4,4-hexafluorobut-2-ene (HFO-1336mzz(E)), cis-1,1,1,4,4,4-hexafluorobut-2-ene (HFO-1336mzz(Z)), trans-1,3,3,3-tetrafluoroprop-1-ene (HFO-1234ze(E)), cis-1,3,3,3-tetrafluoroprop-1-ene (HFO-1234ze(Z)) or mixtures of one or more components thereof.

The chemical blowing agents can be used alone, i.e. without the addition of physical blowing agents, or together with physical blowing agents. The chemical blowing agents are preferably used together with physical blowing agents. In a preferred embodiment the blowing agents (d) comprise aliphatic or cycloaliphatic hydrocarbons with 4 to 8 carbon atoms, especially isomers of pentane, such as isopentane, n-pentane or cyclopentane, or mixtures of isomers of pentane are used as physical blowing agents. More preferred, the blowing agents comprise water or formic acid-water mixtures together with pentane isomers or mixtures of pentane isomers. Alternatively, in case that flammability should be further reduced, the blowing agent comprises HFO, optionally together with chemical blowing agents.

The quantity of blowing agent or blowing agent mixture used in general is 1 to 30% by weight, preferably 1.5 to 20% by weight, particularly preferably 2.0 to 15% by weight, based in each case on the sum of components (b) to (f). If water or a formic acid/water mixture is used as propellant, it is preferably added to component (b) in an amount of 0.2 to 6% by weight, based on the weight of component (b). The addition of water, or the formic acid/water mixture, may be made in combination with the use of the other blowing agents described. Water or a formic acid-water mixture in combination with pentane isomers or mixtures of pentane isomers is preferred.

In particular, compounds are used as catalysts (e) for the production of polyurethane foams which greatly accelerate the reaction of the compounds of components (b) to (f) containing reactive hydrogen atoms, in particular hydroxyl groups, with the polyisocyanates (a).

Basic polyurethane catalysts can be used, such as tertiary amines such as triethylamine, tributylamine, dimethylbenzylamine, dicyclo-hexylmethylamine, dimethylcyclohexylamine, N,N,N′,N′-tetramethyldiaminodiethyl ether, bis(dimethylaminopropyl)urea, N-methyl- or N-ethylmorpholine, N-cyclohexyl morpholine, N,N,N′,N′-tetramethyl ethylenediamine, N,N,N,N-tetramethyl butanediamine, N,N,N,N-tetramethyl hexanediamine-1,6, pentamethyldiethylenetriamine, bis(2-dimethyl¬aminoethyl)ether, dimethylpiperazine, N-dimethyl-aminoethylpiperidine, 1,2-dimethyl¬imidazole, 1-azabicyclo-(2,2,0)octane, 1,4-diazabicyclo.(2,2,2).octane (dabco) and alkanolamine compounds such as triethanolamine, triisopropanolamine, N-methyl- and N-ethyl diethanolamine, dimethylaminoethanol, 2-(N,N-dimethylamino-iethoxy)ethanol, N,N′,N″-tris-(dialkylaminoalkyl)hexahydrotriazines, e.g. N,N′,N″-Tris-(dimethyl¬amino¬propyl)-s-hexahydrotriazine, and triethylenediamine. However, metal salts such as iron(II) chloride, zinc chloride, lead octoate and preferably tin salts such as tin dioctoate, tin diethyl hexoate and dibutyltin dilaurate as well as mixtures of tertiary amines and organic tin salts are also suitable.

Further possible catalysts are: amidines such as 2,3-dimethyl-3,4,5,6-tetrahydro-,pyrimidine, tetraalkylammonium hydroxides such as tetramethylammonium hydroxide, alkali hydroxides such as sodium hydroxide and alkali alcoholates such as sodium methylate and potassium isopropylate, alkali carboxylates as well as alkali salts of long-chain fatty acids with 10 to 20 carbon atoms and optionally side OH groups.

Furthermore, amines which can be incorporated can be considered as catalysts, i.e. preferably amines with an OH, NH or NH2 function, such as ethylenediamine, triethanolamine, diethanolamine, ethanolamine and dimethylethanolamine.

Preferably 0.001 to 10 parts by weight of catalyst or catalyst combination, based on 100 parts by weight of component (b), are used. It is also possible to run the reactions without catalysis. In this case, the catalytic activity of polyols started with amines is usually used.

If a polyisocyanate excess is used for foaming, catalysts for the trimerization reaction of the excess NCO groups with each other can also be considered: Catalysts forming isocyanurate groups, for example ammonium ion or alkali metal salts, especially ammonium or alkali metal carboxylates, alone or in combination with tertiary amines. The isocyanurate formation leads to flame-retardant PIR foams, which are preferably used in technical rigid foams, for example in building materials as insulation boards or sandwich elements.

Other auxiliaries and/or additives (f) may be added to the reaction mixture for the manufacture of the polyurethane foams in accordance with the invention. Examples include surface-active substances, foam stabilizers, cell regulators, fillers, light stabilizers, dyes, pigments, hydrolysis inhibitors, fungistatic and bacteriostatic substances.

As surface-active substances, e.g. compounds can be considered which support the homogenization of the starting materials and are also suitable to regulate the cell structure of the plastics. Examples are emulsifiers such as sodium salts of ricinus oil sulfates or fatty acids as well as salts of fatty acids with amines, e.g. oleic diethylamine, stearic diethanolamine, ricinolic diethanolamine, salts of sulfonic acids, e.g. alkali or ammonium salts of dodecylbenzene or dinaphthylmethanedisulfonic acid and ricinoleic acid; foam stabilizers such as siloxanoxalkylene copolymers and other organopolysiloxanes, oxethylated alkylphenols, oxethylated fatty alcohols, paraffin oils, ricinoleic oil or ricinoleic acid. Ricinoleic acid esters, Turkish red oil and peanut oil, and cell regulators such as paraffins, fatty alcohols and dimethylpolysiloxanes. Oligomeric acrylates with polyoxyalkylene and fluoroalkane residues as side groups are also suitable for improving the emulsifying effect, the cell structure and/or stabilisation of the foam. The surface-active substances are usually applied in quantities of 0.01 to 10 parts by weight, based on 100 parts by weight of component (b).

Common foam stabilizers, such as silicone-based foam stabilizers such as siloxaneox-alkylene copolymers and other organopolysiloxanes and/or oxethylated alkylphenols and/or oxethylated fatty alcohols, can be used as foam stabilizers.

Light stabilizers known in polyurethane chemistry can be used as light stabilizers. These include phenolic stabilizers, such as 3,5-di-tert.butyl-4-hydroxy toluenes and/or Irganox types of BASF, phosphites such as triphenyl phosphite and/or tris(nonylphenyl)phosphite, UV absorbers such as 2-(2-hydroxy-5-methylphenyl) benzotriazoles, 2-(5-chloro-2H-benzotriazol-2-yl)-6-(1,1-dimethylethyl)-4-methylphenol, 2-(2H-benzotriazole-2-yl)-6-dodecyl-4-methylphenol, branched and linear, or 2,2′-(2,5-thiophenediyl)bis[5-tert-butylbenzoxazoles], and so-called HALS stabilizers (hindered amines light stabilizers), such as bis-(1-octyloxy-2,2,6,6,-tetramethyl-4-piperidinyl) se-bacate, n-Butyl-(3,5-ditert-butyl-4-hydroxybenzyl)bis-(1,2,2,6-pentamethyl-4-piperidinyl)malonate or diethyl succinate polymer with 4-hydroxy-2,2,6,6-tetramethyl-1-piperidineethanol.

Fillers, in particular reinforcing fillers, are the usual organic and inorganic fillers known per se. Examples include: inorganic fillers such as silicate minerals, for example layer silicates such as antigorite, serpentine, hornblends, amphibole, chrysotile and talcum, metal oxides such as kaolin, aluminium oxides, titanium oxides and iron oxides, metal salts such as chalk, barite and inorganic pigments such as cadmium sulphide and zinc sulphide, as well as glass and others. Preferably used are kaolin (China clay), aluminium silicate and coprecipitates of barium sulphate and aluminium silicate as well as natural and synthetic fibrous minerals such as wollastonite, metal and especially glass fibres of various lengths, which may be sized if necessary. Organic fillers may include, for example, carbon, melamine, collophonium, cyclopentadienyl resins and graft polymers as well as cellulose fibres, polyamide, polyacrylonitrile, polyurethane and polyester fibres based on aromatic and/or aliphatic dicarboxylic acid esters and, in particular, carbon fibres.

The inorganic and organic fillers can be used individually or as mixtures and are advantageously added to the reaction mixture in amounts of 0.5 to 50 wt. %, preferably 1 to 40 wt. %, based on the weight of components (a) to (f), but the content of mats, nonwovens and fabrics of natural and synthetic fibres may reach values of up to 80 wt. %, based on the weight of components (a) to (f).

Further information on the above-mentioned common auxiliaries and additives (f) can be found in the technical literature, for example the monograph by J.H. Saunders and K.C. Frisch “High Polymers” Vol. XVI, Polyurethanes, Parts 1 and 2, Interscience Publishers 1962 and 1964, or the “Polyurethane Handbook”, Polyurethane, Hanser-Verlag, Munich, Vienna, 2nd edition, 1993.

For the production of rigid polyisocyanate based foams according to the invention the polyisocycanates (a) and the components (b), optionally (c), (d), (e) and optionally (f) are preferably mixed in such amounts that the isocyanate index is in a range between 90 and 160, more preferably between 95 and 140, and especially preferably between 105 and 140. In another preferred embodiment of the invention the isocyanate index is in the range between 170 and 300, preferably 180 and 240. The isocyanate index is the molar ratio of isocyanate groups to groups reactive with isocyanate groups multiplied by 100. In a preferred embodiment components (b), optionally (c), (d), (e) and optionally (f) are mixed to form a polyol component before mixing with the isocyanates (a). In the context of the present invention “reaction mixture” is to be understood as mixture wherein the conversion of the isocyanate groups is less than 90% based on the theoretical conversion with isocyanate reactive groups of the mixture.

The starting components are mixed at a temperature of 15 to 90° C., preferably 20 to 60° C., and in particular 20 to 45° C. The reaction mixture can be obtained by mixing in high or low pressure dosing machines and introducing the reaction mixture into closed molds. According to this technology, discontinuous sandwich elements, for example, are produced.

The rigid foams according to the invention are preferably produced on continuously operating double belt lines. Here the polyol and isocyanate components are dosed with a high-pressure machine and mixed in a mixing head. Catalysts and/or blowing agents can be dosed into the polyol mixture beforehand using separate pumps. The reaction mixture is continuously applied to the lower layer. The lower lower layer with the reaction mixture and the upper top layer enter the double belt in which the reaction mixture foams and hardens. After leaving the double belt, the endless strand is cut into the desired dimensions. In this way, sandwich elements with metallic cover layers or insulation elements with flexible cover layers can be produced.

As lower and upper cover layers, which can be the same or different, flexible or rigid cover layers usually used in the double belt method can be used. These include metal face sheets such as aluminium or steel, bitumen face sheets, paper, nonwovens, plastic sheets such as polystyrene, plastic films such as polyethylene films or wood face sheets. The top layers can also be coated, for example with a conventional lacquer.

Rigid polyisocyanate based foams produced according to the invention have a density of 0.02 to 0.75 g/cm³, preferably 0.025 to 0.24 g/cm³ and in particular 0.03 to 0.1 g/cm³.

They are particularly suitable as insulation material in the construction or cooling sector, e.g. as intermediate layer for sandwich elements.

The rigid polyisocyanate based foams according to the invention are characterized by a particularly high flame retardancy and therefore allow the use of reduced quantities of flame retardants, in particular a reduced quantity of toxic halogenated flame retardants. Preferably, the rigid foams according to the invention have a flame height of less than 15 cm according to a test according to EN-ISO 11925-2.

Furthermore, the PUR rigid foams in accordance with the invention meet all necessary requirements for good processability and end product properties even at low mould temperatures of less than 55° C. and without additional adhesion promoter. Especially polyisocyanate based foams according to the invention show fast foam curing, good foam adhesion on metallic surface layers, few defects on the foam surface, good compressive strength and good thermal insulation properties.

The following examples will illustrate this invention:

### EXAMPLES

Polyol 1: A rigid foam polyether polyol having a hydroxyl number of 490 mg KOH/g, and an average OH-functionality of 4.3 based on propylene oxide and a mixture of sucrose and glycerol as starter.

Polyol 2: An aromatic polyesterpolyol based on terephthalic acid, oleic acid, diethylene glycol and ethoxylated glycerol with an OH-value of 535 has been produced. The Ester has an average OH-functionality of 2.5 and a hydroxyl number of 242.

Polyol 3: Alkoxylation product of trimethylolpropane with ethylene oxide having a hydroxyl number of 650 mg KOH/g, and an average OH-functionality of 3 Polyol 4: Alkoxylated mannich-base, 450 mg KOH/g, obtainable under the trade name “Rokopol©RF151” from PCC-Rokita S.A.

Polyol 5: Aromatic novolac based polyetherpolyol obtained by condensation of phenol and formaldehyde and subsequent alkoxylation as described below having an OH-value of 287 mg KOH/g.

Polyol 6: Alkoxylation product of glycerol with ethylene oxide having a hydroxyl number of 400 mg KOH/g, and an average OH-functionality of 3.

Polyol 7: Aromatic polyetherpolyol 3 (bitte beschreiben was genau “Desmophen© M 530”, 530 mg KOH/g ist (Ausgangsmaterialien, OHZ, Funktionalitst, ggf. mit Synthesevorschrift)).

Polyol 8: Mixture of dipropylene glycol, glycerol and water (weight ratio 30:10:60).

Polyol 9: Aromatic novolac based polyetherpolyol obtained by condensation of phenol and formaldehyde and subsequent alkoxylation as described below having an OH-value of 204 mg KOH/g.

Polyol 10: Aromatic novolac based polyetherpolyol obtained by condensation of phenol and formaldehyde and subsequent alkoxylation as described below having an OH-value of 303 mg KOH/g.

Polyol 11: Aromatic novolac based polyetherpolyol obtained by condensation of phenol and formaldehyde and subsequent alkoxylation as described below having an OH-value of 317 mg KOH/g.

Polyol 12: Aromatic novolac based polyetherpolyol obtained by condensation of phenol and formaldehyde and subsequent alkoxylation as described below having an OH-value of 306 mg KOH/g.

Polyol 13: Aromatic novolac based polyetherpolyol obtained by condensation of phenol and formaldehyde and subsequent alkoxylation as described below having an OH-value of 318 mg KOH/g.

Polyol 14: Aromatic novolac based polyetherpolyol obtained by condensation of phenol and formaldehyde and subsequent alkoxylation as described below having an OH-value of 287 mg KOH/g.

Polyol 15: Aromatic polyetherpolyol, obtainable by condensation of Cardanol and formaldehyde and subsequent prpoxylation, OH-number 175 mg KOH/g, functionality 3.8, commercially available from Cardolite Corporation under the trade name “Novolak Cardanol NX 9001 LV”.

Polyol 16: Aromatic polyetherpolyol, obtainable by condensation of Cardanol and formaldehyde and subsequent prpoxylation, OH-number 175 mg KOH/g, functionality 4.4, commercially available from Cardolite Corporation under the trade name “Novolak Cardanol NX 9001”.

Polyol 17: Aromatic polyetherpolyol, obtainable by condensation of Cardanol and formaldehyde and subsequent prpoxylation, OH-number 170 mg KOH/g, functionality 4.3, commercially available from Cardolite Corporation under the trade name “Novolak Cardanol NX LITE 9001 LV”. 7

Flame retardant 1: Tris(1-chloro-2-propyl) phosphate

Flame retardant 2: Triethyl phosphate

Flame retardant 3: mixture of 50 wt.-% tris-(2-chloroisopropyl)-phosphate (TCPP) and 50 wt.-% tribromoneopentylalcohol (TBNPA)

Catalyst 1: N,N-Dimethylcyclohexylamine

Catalyst 2: Potassium acetate in monoethylene glycol about 18 wt.-% Potassium

Catalyst 3: N,N,N′,N″,N″-Pentamethyldiethylenetriamine (PMDETA)

Stabilizer: Silicone based surfactant

Blowing agent 1: mixture of n-/iso pentane (80:20 by weight)

Blowing agent 2:water

Iso: mixture of monomeric MDI and higher homologues of MDI (obtainable at BASF under the trade name Lupranat© M50)

The aromatic novolac based polyetherols 9 to 14 is obtained from condensation of phenole and formaldehyde having a number average molar weight of 305 g/mol and an average functionality of about 3 (OH-number about 550 mg KOH/g). The so obtained aromatic starting molecule (Bakelite 8505F) is subsequently alkoxylated.

Polyol 5:

A 600|pressure reactor with agitator, jacket heating and cooling, dosing equipment for solid and liquid substances and alkylene oxides as well as equipment for nitrogen inerting and a vacuum system was heated to 80° C. and inerted several times with nitrogen. 312.7 kg glycerol and 3.75 kg 50 wt-% aqueous KOH solution were poured into the reactor and the stirrer was put into operation. The temperature was then raised to 120° C. and a mixture of 228.9 kg propylene oxide and 57.2 kg ethylene oxide (constant ratio over the entire dosing time) was added. The dosing time was 4.5 h. The after-reaction of 2 hours took place at 120° C. The sample was then stripped in a nitrogen stream. 530 kg of product with the following parameters were obtained.

OH #287 mg KOH/g

Viscosity (75° C.) 616 mPas

Water content 0.04%

Polyol 9:

1753.8 g Bakelite 8505F and 28.52 g of an aqueous KOH solution (50% by weight) were added to a 5-litre pressure reactor. The reactor is equipped with stirrer, jacket heating and cooling, measuring equipment for alkylene oxides, metering facilities, vacuum system and equipment for interting with nitrogen. The reactor was inertised three times with nitrogen and then the starter mixture was heated to 120° C. The starter mixture was then dried for 3 hours under vacuum (15 mbar). Then a mixture of 2358 g propylene oxide and 589 g ethylene oxide was added for 10 hours. This was followed by an after-reaction for four hours at 120° C. The reaction mixture was spripped with nitrogen for 20 minutes and then cooled down to 40° C. The reaction was then repeated for a further 20 minutes. 4722 g of a colorless oil with the following specifications were obtained:

OH number: 204 mg/KOH g

Viscosity (at 25° C.): 14200 mPas

Polyol 10:

1878.8 g Bakelite 8505F and 20.30 g of an aqueous KOH solution (50% by weight) were added to a 5-litre pressure reactor. The reactor is equipped with stirrer, jacket heating and cooling, measuring equipment for alkylene oxides, metering facilities, vacuum system and equipment for interting with nitrogen. The reactor was inertised three times with nitrogen and then the starter mixture was heated to 120° C. The starter mixture was then dried for 3 hours under vacuum (15 mbar). Then 1480 g propylene oxide was added for 5 hours. This was followed by an after-reaction for four hours at 120° C. The reaction mixture was spripped with nitrogen for 20 minutes and then cooled down to 40° C. 3304 g of a colorless oil with the following specifications were obtained:

OH number: 303 mg/KOH g

Viscosity (bei 75° C.): 1690 mPas

Polyol 11:

139.58 g Bakelite 8505F and 1.51 g of an aqueous KOH solution (50% by weight) were added to a 300 ml pressure reactor. The reactor is equipped with stirrer, jacket heating and cooling, measuring equipment for alkylene oxides, metering facilities, vacuum system and equipment for interting with nitrogen. The reactor was inertised three times with nitrogen and then the starter mixture was heated to 120° C. The starter mixture was then dried for 3 hours under vacuum (15 mbar). Then a mixture of 54.96 g ethylene oxide and 54.96 g propylene oxide was added for 5 hours (constant composition during entire dosing period). This was followed by an after-reaction for four hours at 120° C. The reaction mixture was spripped with nitrogen for 20 minutes and then cooled down to 40° C. 227 g of a colorless oil with the following specifications were obtained:

OH number: 317 mg/KOH g

Viscosity (bei 75° C.): 973 mPas

Polyol 12:

135.43 g Bakelite 8505F and 1.50 g of an aqueous KOH solution (50% by weight) were added to a 300 ml pressure reactor. The reactor is equipped with stirrer, jacket heating and cooling, measuring equipment for alkylene oxides, metering facilities, vacuum system and equipment for interting with nitrogen. The reactor was inertised three times with nitrogen and then the starter mixture was heated to 120° C. The starter mixture was then dried for 3 hours under vacuum (15 mbar). Then 114.06 g ethylene oxide was added for 4 hours. This was followed by an after-reaction for four hours at 120° C. The reaction mixture was spripped with nitrogen for 20 minutes and then cooled down to 40° C. 221 g of a colorless oil with the following specifications were obtained:

OH number: 306 mg/KOH g

Viscosity (bei 75° C.): 665 mPas

Polyol 13:

139.58 g Bakelite 8505F and 1.51 g of an aqueous KOH solution (50% by weight) were added to a 300 ml pressure reactor. The reactor is equipped with stirrer, jacket heating and cooling, measuring equipment for alkylene oxides, metering facilities, vacuum system and equipment for interting with nitrogen. The reactor was inertised three times with nitrogen and then the starter mixture was heated to 120° C. The starter mixture was then dried for 3 hours under vacuum (15 mbar). Then 54.96 g ethylene oxide was added for 3 hours. After an abreaction of 2 hours, 54.96 g propylene oxide were added for 3 hours. This was followed by an after-reaction for four hours at 120° C. The reaction mixture was spripped with nitrogen for 20 minutes and then cooled down to 40° C. 230 g of a colorless oil with the following specifications were obtained:

OH number: 318 mg/KOH g

Viscosity (bei 75° C.): 1245 mPas

Polyol 14:

139.64 g Bakelite 8505F and 1.50 g of an aqueous KOH solution (50% by weight) were added to a 300 ml pressure reactor. The reactor is equipped with stirrer, jacket heating and cooling, measuring equipment for alkylene oxides, metering facilities, vacuum system and equipment for interting with nitrogen. The reactor was inertised three times with nitrogen and then the starter mixture was heated to 120° C. The starter mixture was then dried for 3 hours under vacuum (15 mbar). Then 54.96 g propylene oxide was added for 3 hours. After an abreaction of 2 hours, 54.96 g ethylene oxide were added for 3 hours. This was followed by an after-reaction for four hours at 120° C. The reaction mixture was spripped with nitrogen for 20 minutes and then cooled down to 40° C. 230 g of a colorless oil with the following specifications were obtained:

OH number: 313 mg/KOH g

Viscosity (bei 75° C.): 1265 mPas

Polyurethane rigid foams were prepared from the compounds mentioned in the tables (all numbers given in parts by weight unless otherwise stated). To prepare the foams, polyol, flame retardant, catalyst, stabilizer and blowing agent were combined to a polyol component. Subsequently the polyol component was mixed with the isocyanate. 80 grams of the so formed reaction mixture was poured into a paper cup and to produce the polyurethane foam.

The test specimens for were manufactured as follows:

Polyol, flame retardant, catalyst, stabilizer and blowing agent were combined to a polyol component. Subsequently, the polyol component was mixed with the isocyanate. 260 g of the reaction mixture, were intensively stirred in a paper cup with the aid of a laboratory agitator for 10 seconds and transferred into a box form with the internal dimensions 15 cm×25 cm. After complete curing of the reaction mixture (24 hours after production) the resulting rigid foam block was demoulded and shortened by 3 cm at all edges. The test specimens with the dimensions: 190×90×20 mm were then conditioned for one day and tested according to DIN EN-ISO 11925-2 using edge flaming on the 90 mm side.

Further test specimens with the dimensions 100 mm×100 mm×100 mm were removed from the test specimens. The compressive strength of the foam was determined according to EN 826. Start time, fiber time and rise time were determined according to ASTM D 7487-18 “Standard practice for polyurethane raw materials: Polyurethane foam cup test”.

Explanation of the Catalyst [%] specification: The systems were set to the same setting times with regard to reactivity by increasing (+) or decreasing (−) the amount of catalyst relative to Example 1 (V). All catalysts were changed by the specified percentage value.

TABLE 1

| | System 1 | | | | | |
|---|---|---|---|---|---|---|
| | 1 (V) | 2(V) | 6 | 7 (V) | 8 (V) | 9 (V) |
| Polyol 1 | 26 | 26 | 26 | 26 | 26 | 26 |
| Polyol 2 | 27.2 | 27.2 | 27.2 | 27.2 | 27.2 | 27.2 |
| Polyol 3 | 5.5 | 5.5 | 5.5 | 5.5 | 5.5 | 5.5 |
| Polyol 4 | 10 | | | | | |
| Polyol 5 | | 10 | — | — | — | — |
| Polyol 6 | | | | | | |
| Polyol 7 | | | | | | |
| Polyol 8 | | | | | | |
| Polyol 9 | — | — | 10 | — | — | — |
| Polyol 10 | — | — | — | 10 | — | — |
| Polyol 11 | — | — | — | — | 10 | — |
| Polyol 12 | — | — | — | — | — | 10 |
| Flame retar- | 24 | 24 | 24 | 24 | 24 | 24 |
| dant 1 | | | | | | |
| Flame retar- | 3.5 | 3.5 | 3.5 | 3.5 | 3.5 | 3.5 |
| dant 2 | | | | | | |
| Flame retar- | | | | | | |
| dant 3 | | | | | | |
| Catalyst 1 | 2.3 | 2.8 | 2.7 | 2.9 | 2.7 | 2.2 |
| Catalyst 2 | | | | | | |
| Catalyst 3 | | | | | | |
| Stabilizer | 2.5 | 2.5 | 2.5 | 2.5 | 2.5 | 2.5 |
| Blowing | 5.5 | 5.5 | 5.5 | 5.5 | 5.5 | 5.5 |
| agent 1 | | | | | | |
| Blowing | 0.5 | 0.5 | 0.5 | 0.5 | 0.5 | 0.5 |
| agent 2 | | | | | | |
| Iso | 200 | 200 | 200 | 200 | 200 | 200 |
| start time [s] | 14 | 13 | 14 | 14 | 14 | 14 |
| fiber time [s] | 39 | 39 | 39 | 39 | 39 | 39 |
| Rise time [s] | 63 | 63 | 62 | 63 | 63 | 63 |
| Density [g/l] | 42 | 42 | 42 | 42 | 42 | 42 |
| B2-Test [cm] | 14 | 12,8 | 13.5 | 13.8 | 14.4 | 13.5 |
| Compression | 0.18 | 0.16 | 0.17 | 0.17 | 0.16 | 0.15 |
| strength | | | | | | |
| [N/mm²] | | | | | | |
| Catalyst [%] | 0 | 22 | 17 | 26 | 17 | −4 |
| | System 1 | | | | | |
| | 10 (V) | 11 | 12 (V) | 13 (V) | 14 (V) | 15 (V) |
| Polyol 1 | 26 | 26 | 26 | 26 | 26 | 26 |
| Polyol 2 | 27.2 | 27.2 | 27.2 | 27.2 | 27.2 | 27.2 |
| Polyol 3 | 5.5 | 5.5 | 5.5 | 5.5 | 5.5 | 5.5 |
| Polyol 11 | 10 | | | | | |
| Polyol 13 | | 10 | | | | |
| Polyol 14 | | | 10 | | | |
| Polyol 15 | | | | 10 | | |
| Polyol 16 | | | | | 10 | |
| Polyol 17 | | | | | | 10 |
| Flame retar- | 24 | 24 | 24 | 24 | 24 | 24 |
| dant 1 | | | | | | |
| Flame retar- | 3.5 | 3.5 | 3.5 | 3.5 | 3.5 | 3.5 |
| dant 2 | | | | | | |
| Flame retar- | | | | | | |
| dant 3 | | | | | | |
| Catalyst 1 | 2.7 | 2.6 | 2.7 | 3.1 | 2.9 | 2.8 |
| Catalyst 2 | | | | | | |
| Catalyst 3 | | | | | | |
| Stabilizer | 2.5 | 2.5 | 2.5 | 2.5 | 2.5 | 2.5 |
| Blowing | 5.5 | 5.5 | 5.5 | 5.5 | 5.5 | 5.5 |
| agent 1 | | | | | | |
| Blowing | 0.5 | 0.5 | 0.5 | 0.5 | 0.5 | 0.5 |
| agent 2 | | | | | | |
| Iso | 200 | 200 | 200 | 200 | 200 | 200 |
| start time | 13 | 14 | 14 | 14 | 14 | 13 |
| fiber time | 39 | 39 | 39 | 39 | 39 | 39 |
| Rise time | 63 | 62 | 63 | 62 | 63 | 63 |
| Density [g/l] | 42 | 42 | 42 | 42 | 42 | 42 |
| B2-Test [cm] | 14.4 | 13.7 | 14.4 | 14.1 | 13.8 | 13.6 |
| Compression | 0.16 | 0.18 | 0.16 | 0.15 | 0.15 | 0.15 |
| strength | | | | | | |
| [N/mm²] | | | | | | |
| Catalyst [%] | 17 | 13 | 17 | 33 | 26 | 22 |

It can be seen from the tables that the use of an aromatic polyol according to the present invention results in improved flame retardancy and compression strength compared to aromatic polyols according to the state of the art (Mannich Polyols) or novolac polyols having a hydroxyl number outside the claimed range of 220 to 400. Flame retardancy and compression strength of the isocyanate based foams according to the invention is also improved compared to foams prepared with polyols having an ethylene to propyleneoxide ratio outside the claimed ration of 70:30 to 95 to 5.

Further improvement can be obtained by using a specific dosing sequence when performing the alcoxylation of the aromatic polyol. So flame retardancy and compression strength of the isocyanate based foams according to the invention are further improved when the starting molecule of the aromatic polyetherpolyol is first ethoxylated and in a second step propoxylated compared to a random alkoxylation or an alkoxylation wherein first propylene oxide and then ethylene oxide is added to the starter (see example 8 compared to 7 and 9.

1. A method for the preparation of a rigid polyisocyanate based foam,
comprising mixing
a) polyisocyanate,
b) at least one compound having at least two hydrogen atoms reactive towards isocyanates,
c) optionally flame retardant,
d) blowing agent,
e) catalyst and
f) optionally further additives,
to form a reaction mixture and reacting the reaction mixture to obtain the polyurethane based rigid foam,
wherein the compound reactive towards isocyanates (b) comprises an aromatic polyetherpolyol (b2) and at least one compound selected from the group consisting of an aromatic polyesterpolyol (b1) and a polyetherpolyol (b3) different from polyether (b2), the polyetherpolyol (b2) obtainable by condensation of an aromatic alcohol and an aldehyde to form a starting molecule and subsequent alkoxylation with alkylene oxide comprising ethylene oxide and propylene oxide wherein a weight ratio of propylene oxide and ethylene oxide is 70:30 to 95:5 and the hydroxyl number is 220 to 400 mg KOH/g.

2. The method according to claim 1, wherein the aromatic polyether polyol (b2) has a hydroxyl number of 250 to 350 mg KOH/g and the weight ratio of propylene oxide and ethylene oxide of 70:30 to 90:10.

3. The method according to claim 1, wherein the aromatic polyether polyol (b2) has an average OH-functionality of 2.7 to 5.

4. The method according to claim 1, wherein the polyetherol (b2) has less than 30% of primary OH groups, based on a total number of OH-Groups in the polyetherol (b2).

5. The method according to claim 1, wherein the aromatic alcohol is unsubstituted phenol.

6. The method according to claim 1, wherein the polyetherpolyol (b2) comprises 60 to 100% secondary OH-groups, based on a total number of OH groups in polyetherpolyol (b2).

7. The method according to claim 1, wherein the aromatic polyesterpolyol (b1) is obtainable by esterification of dicarboxylic acid composition comprising one or more aromatic dicarboxylic acids or derivatives thereof, one or more fatty acids or fatty acid derivatives, one or more aliphatic or cycloaliphatic alcohols with functionality of 2 or more having 2 to 18 carbon atoms or alkoxylates thereof.

8. The method according to claim 1, wherein the compound having at least two hydrogen atoms reactive towards isocyanates (b) comprises an aromatic polyesterpolyol (b1) and a polyether (b3), different from polyether (b2).

9. The method according to claim 1, wherein the blowing agent comprises pentane.

10. The method according to claim 1, wherein the blowing agent comprises Hydrofluoroolefines.

11. The method according to claim 1, wherein the blowing agent comprises formic acid.

12. The method according to claim 1, wherein the compound having at least two hydrogen atoms reactive towards isocyanates (b) and catalysts are combined to form an isocyanate reactive compound and the isocyanate reactive compound is reacted with polyisocyanates (a) to form the polyisocyanate based foam.

13. The method according to claim 1, wherein an isocyanate index is in a range of 95 to 140.

14. The method according to claim 1, wherein an isocyanate index is in a range of 170 to 300.

15. A polyol component comprising compound having at least two hydrogen atoms reactive towards isocyanates (b), optionally flame retardants (c), blowing agents (d), catalysts (e) and optionally further additives (f), wherein the compound reactive towards isocyanates (b) comprises an aromatic polyetherpolyol (b2) and at least one compound selected from the group consisting of an aromatic polyesterpolyol (b1) and a polyetherpolyol (b3) different from polyether (b2), the aromatic polyetherpolyol (b2) obtainable by condensation of an aromatic alcohol and an aldehyde to form a starting molecule and subsequent alkoxylation with alkylene oxide comprising ethylene oxide and propylene oxide wherein a weight ratio of propylene oxide and ethylene oxide is 70:30 to 95:5 and the hydroxyl number is 220 to 400 mg KOH/g.

16. A rigid polyisocyanate based foam, obtainable according to the method of claim 1.
